(19) United States
(12) Patent Application Publication
(10) Pub. No.: US 2005/0267815 A1
(43) Pub. Date: Dec. 1, 2005

(54) Customized support experiences based on POS choices

(76) Inventors: James A. Howell JR., Georgetown, TX (US); Shannon Christopher Boesch, Austin, TX (US)

Correspondence Address: HAMILTON & TERRILE, LLP, P.O. BOX 203518, AUSTIN, TX, 78720, US

(21) Appl. No.: 10/858,265

(22) Filed: Jun. 1, 2004

(51) Int. Cl. G06F 17/60

(52) U.S. Cl. 705/26

(57) ABSTRACT

A system for customizing support of an information handling system which includes an order determination module and a support customization module. The order determination module determines items ordered by a customer at a point of sale of the information handling system. The support customization module customizes support information presented on the information handling system based upon the items ordered by the customer.

### BACKGROUND OF THE INVENTION

1. Field of the Invention

The present invention relates to information handling system support and more particularly to customizing support experiences based upon point of sale (POS) choices.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

When dealing with information handling system customer support, customers are provided with a broad but standard experience. I.e., support is broadly available, but not tailored to any decisions made during the purchasing of the information handling system. For example, instead of having text such as “download this driver if you have video card X”, or “download this driver is you have video card Y”, it is desirable to customize the support based upon an ordered system of the customer.

This issue is particularly relevant when the ordered information handling system is a build to order computer system. A goal of information handling system manufacturers is to reduce overall customer support costs by enabling customers to support themselves.

### SUMMARY OF THE INVENTION

In accordance with the present invention, a process by which support content is specifically tailored to what was purchased at the point of sale. Support applications are modified to include logic that comprehends what hardware, software and services were purchased and then to tailor initial support content based upon the specific configuration of the ordered information handling system.

In one embodiment, the invention relates to a method for customizing support of an information handling system which includes determining items ordered by a customer at a point of sale of the information handling system and customizing support information presented on the information handling system based upon the items ordered by the customer.

In another embodiment, the invention relates to an apparatus for customizing support of an information handling system which includes means for determining items ordered by a customer at a point of sale of the information handling system and means for customizing support information presented on the information handling system based upon the items ordered by the customer.

In another embodiment, the invention relates to a system for customizing support of an information handling system which includes an order determination module and a support customization module. The order determination module determines items ordered by a customer at a point of sale of the information handling system. The support customization module customizes support information presented on the information handling system based upon the items ordered by the customer.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a schematic diagram of a system for installing software.

FIG. 2 shows a schematic block diagram of an information handling system including a customized support application.

FIG. 3 shows a block diagram showing the operation of a system for customizing support experiences.

FIG. 4 shows an example of the operation of a customized support experience.

FIG. 5 shows another example of the operation of a customized support experience.

FIG. 6 shows another example of the operation of a customized support experience.

### DETAILED DESCRIPTION

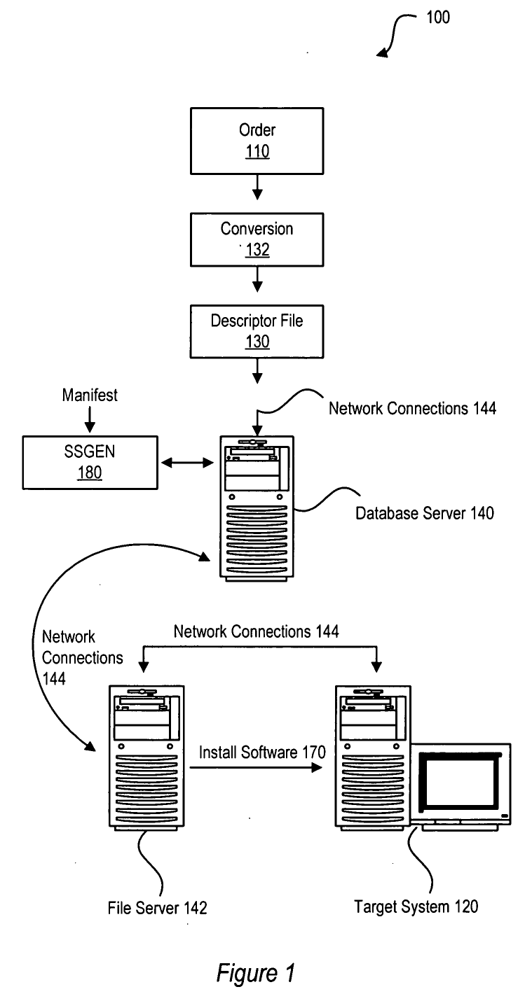

FIG. 1 is a schematic diagram of a software installation system 100 at an information handling system manufacturing site. In operation, an order 110 is placed to purchase a target information handling system 120. The target information handling system 120 to be manufactured contains a plurality of hardware and software components. For instance, target information handling system 120 might include a certain brand of hard drive, a particular type of monitor, a certain brand of processor, as well as particular software products and preordered services. The software may include a particular version of an operating system along with all appropriate driver software and other application software along with appropriate software bug fixes. Before target information handling system 120 is shipped to the customer, the plurality of components are installed and tested. Such software installation and testing advantageously ensures a reliable, working information handling system which is ready to operate when received by a customer.

Because different families of information handling systems and different individual computer components may require different software installations, it is desirable to determine which software to install on a target information handling system 120. A descriptor file 130 is provided by converting an order 110, which corresponds to a desired information handling system having desired components, into a computer readable format via conversion module 132.

Component descriptors are computer readable descriptions of the components of target information handling system 120 which components are defined by the order 110. In a preferred embodiment, the component descriptors are included in a descriptor file called a system descriptor record which is a computer readable file containing a listing of the components, both hardware and software, to be installed onto target information handling system 120. Having read the plurality of component descriptors, database server 140 provides an image having a plurality of software components corresponding to the component descriptors to file server 142 over network connection 144. Network connections 144 may be any network connection well-known in the art, such as a local area network, an intranet, or the internet. The information contained in database server 140 is often updated such that the database contains a new factory build environment. The software is then installed on the target information handling system 120 via file server 142. The software is installed on the target information handling system via the image. The image may include self-configuring code.

The database server 140 may also be updated via a software stack generator machine 180. The software stack generator (SSGEN) machine 180 is capable of downloading and installing a configurable set of software parts and then automatically capturing an image of the contents, optionally uploading the image to a shared server such as the database server 140 for later use. The software stack generator machine 180 is capable of being controlled by a centralized front end, thus allowing two or more software stack generator machines to be set up in an image building farm.

In operation, automating the generation of images provides the ability to download the parts to be installed into the image from a network or other storage device. The software stack generator machine 180 may include scriptable package delivery mechanisms. The software stack generator machine 180 may include or receive images which include an integrated rapid install system (IRIS). The integrated rapid install system may then be installed onto the target system when the image is installed onto the target system.

Images to be created are described using a manifest which is represented, e.g., as an XML document. The contents of the image include some or all of a base operating system, application programs, applets (for hardware), etc. The manifest is provided to the software stack generator machine 142 and causes the image building process to begin. After the image is created, the image can be installed onto a target system 120 such that the building of the image is transparent to the target system. For example, the SSGEN machine 180 removes anything from the registry of the operating system that would indicate that the software stack was created by the SSGEN machine 180.

The components also include a customized customer support application. The customized customer support application includes a process by which support content is specifically tailored to what was purchased at the point of sale. The customer support application includes a configuration determination module and a tailored customer support module. The configuration determination module of the customer support application comprehends what hardware, software and services were purchased. The tailored customer support module uses the information determined by the configuration determination module to tailor initial support content based upon the specific configuration of the target information handling system 120.

For example, instead of providing generic instructions for “How do I get on the Internet?” the target information handing system 120 includes specific content on “How do I get online with the services promotion that was included with my system purchase.” Thus, the customer support application provides customized support experience which includes relevant support information and does not provide the user with too much irrelevant information or having to provide information which the user needs to understand to structure a query to obtain the information that the customer needs.

During the installation of the customized customer support application, the support application generates XPATH queries based upon the system order 110. These queries are then used to reduce and focus support content which is loaded on the target information handling system 120 in a generic format, such as an XML format. When a customer accesses the customer support application, the customer has the option of using a simplified and focused support experience or turning off the focused content and to thus view all unfiltered content. The customized customer support application enables an information handling system manufacturer to reduce call volume regarding “how to” questions. The customized customer support application is especially beneficial as information handling systems offer more complex service based applications and hardware configurations.

The customized customer support application tailors support content for service based applications such as internet services provider applications or digital entertainment applications, but is also applicable to hardware support content.

Additionally, the process can further tailor a support experience based upon decisions that are made by the user during configuration of the ordered information handling system such as whether a particular service has been activated by the user. For example, if a user has not registered for or activated a service based application, the support experience would show the user how to register or activate the service. Alternately, if a user has registered or activated the service based application, then the support experience would be tailored to display content relating to how to user the service.

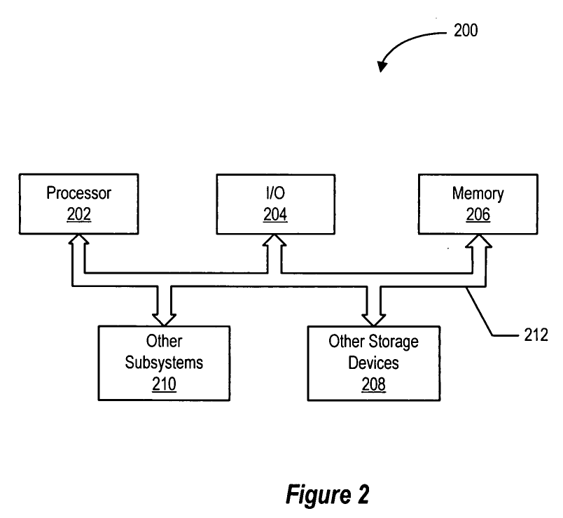

Referring to FIG. 2, a system block diagram of a target information handling system 120 is shown. The information handling system 120 includes a processor 202, input/output (I/O) devices 204, such as a display, a keyboard, a mouse, and associated controllers, non-volatile memory such as a hard disk drive 206, and other storage devices 208, such as a floppy disk and drive and other memory devices, and various other subsystems 210, all interconnected via one or more buses, shown collectively as bus 312. A customized support application 240 is stored on non-volatile memory 306 of the information handling system 120 and is executed by the processor 202 of the information handling system 120. The information handling system 120 also includes information indicating any components or services that were ordered at the point of sale of the information handling system 120.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

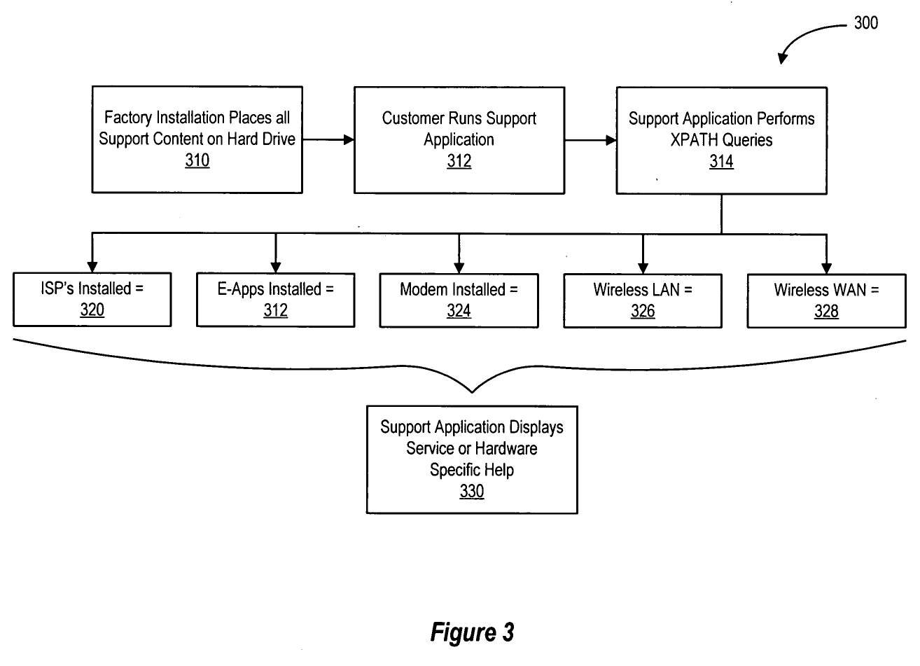

Referring to FIG. 3, a block diagram showing the operation of a system for customizing support experiences 300 is shown. More specifically, the factory installation process stores all support content onto the target system 120, in e.g., the hard drive of the target system 120. When the system 120 is shipped to the customer, the customer may execute the support application 240 on the target system at step 312. The customized support application 240 performs queries, (e.g., XPATH queries or SDR queries) to determine particular services or components that were installed based upon the customer's activities at the point of sale at step 314. For example, the support application determines what internet service providers (ISPs) were installed at step 320, what electronic applications (E-Apps) were installed at step 322, what modem or modems were installed at step 324, what wireless local area network (LAN) components were installed at step 326 and what wireless wide area network (WAN) components were installed at step 328. The support application might also determine any other types of components or services are present. The support application then displays service or hardware specific help information at step 330 based upon which services and components were installed on the target system 120.

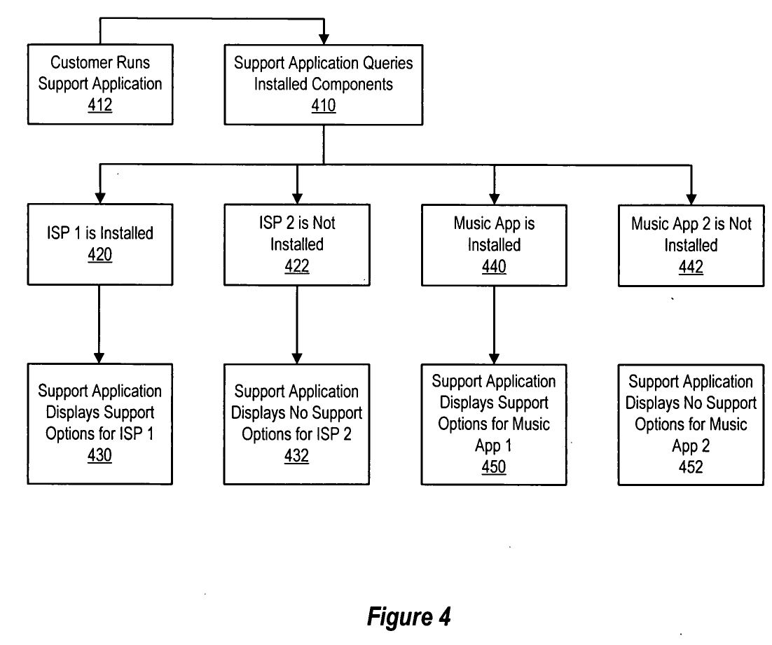

Referring to FIG. 4, an example of the operation of a customized support experience is shown. The customer executes the support application on the target system at step 212. The support application performs queries to determine particular components that were installed based upon the customer's activities at the point of sale at step 410. For example, the support application might determine that a first ISP is installed at step 420 while a second ISP is not installed at step 422. The support application thus presents support options relating to the first ISP at step 430 but does not present support options for the second ISP at step 432. Additionally, the support application might determine that a first music application is installed at step 440 while a second music application is not installed at step 442. The support application thus presents support options relating to the first music application at step 450 but does not present support options for the second music application at step 452.

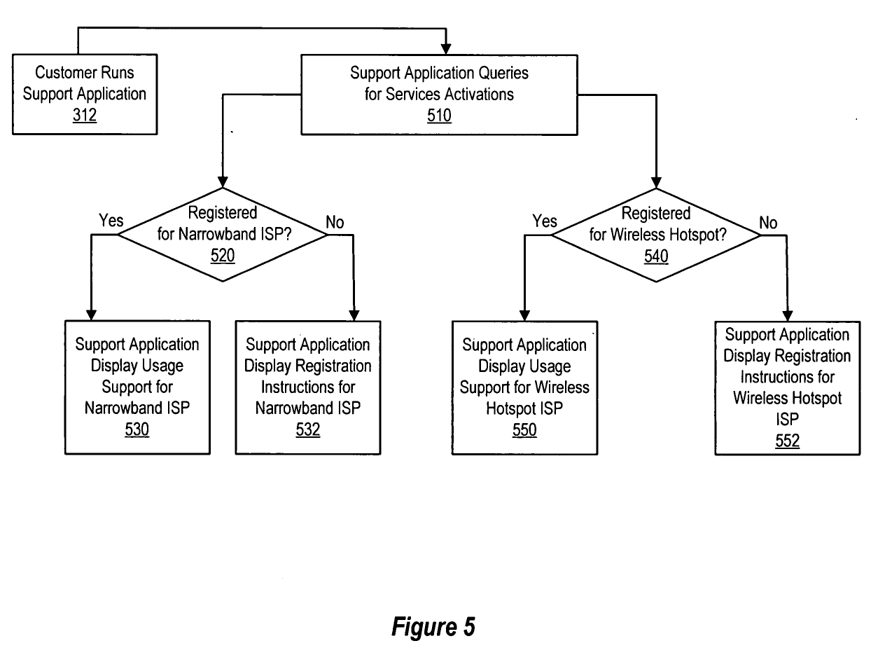

Referring to FIG. 5, another example of the operation of a customized support experience is shown. The customer executes the support application on the target system at step 212. The support application performs queries to determine particular services were activated based upon the customer's activities at the point of sale at step 510. For example, the support application determines whether a narrowband ISP service was registered at step 520. If a narrowband ISP service was registered, then the support application presents support options relating to usage support for the narrowband ISP at step 530. If a narrowband ISP services was not registered, then the support application presents registration instructions to facilitate the customer registering for a narrowband ISP at step 532. Also, the support application determines whether a wireless hotspot services provider was registered at step 540. If a wireless hotspot service was registered, then the support application presents support options relating to usage support for the wireless hotspot at step 550. If a wireless hotspot services was not registered, then the support application presents registration instructions to facilitate the customer registering for a wireless hotspot services provider at step 552.

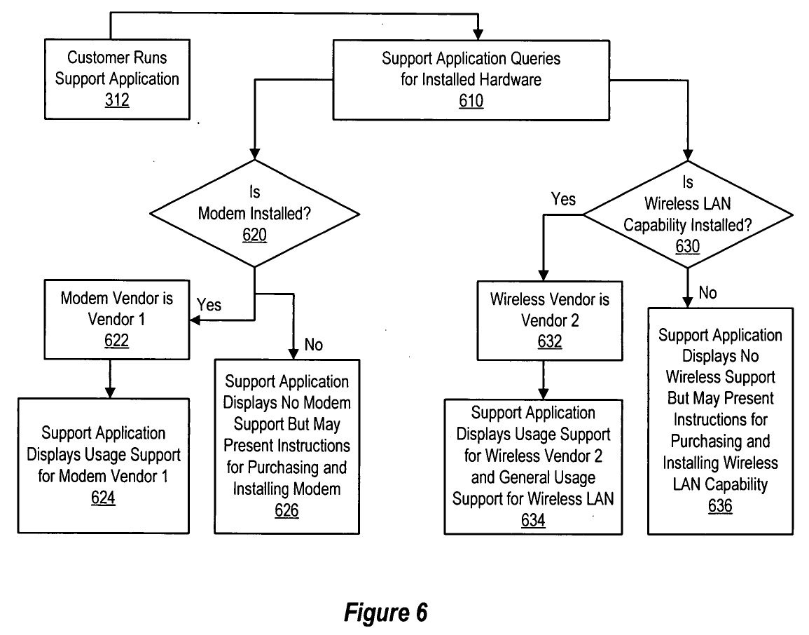

Referring to FIG. 6, another example of the operation of a customized support experience is shown. The customer executes the support application on the target system at step 212. The support application performs queries to determine what hardware is installed on the information handling system 120 activated based upon the customer's activities at the point of sale at step 610. For example, the support application determines whether a modem was installed based upon the configuration of the information handing system at the time the information handling system was ordered at step 620. If a modem was installed, then the support application determines the type of modem that was installed at step 622 and then presents usage support for the particular type of modem at step 624. If no modem was installed, then the support application presents instructions for purchasing and installing a modem at step 626. The support application determines whether a wireless local area network was installed based upon the configuration of the information handing system at the time the information handling system was ordered at step 630. If a wireless LAN was installed, then the support application determines the type of wireless LAN that was installed at step 632 and then presents usage support for the particular type of wireless LAN at step 634. If no wireless LAN was installed, then the support application presents instructions for purchasing and installing a modem at step 636.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

1. A method for customizing support of an information handling system comprising:
determining items ordered by a customer at a point of sale of the information handling system;
customizing support information presented on the information handling system based upon the items ordered by the customer.

2. The method of claim 1 wherein:
the determining includes querying installation information to determine items ordered by the customer.

3. The method of claim 1 wherein:
the items ordered by the customer include subscription services.

4. The method of claim 3 wherein:
when the determining determines subscription services have been ordered by the customer, the information presented on the information handling system includes information relating to usage support of the subscription services; and,
when the determining determines that subscription services have not been ordered by the customer, the information presented on the information handling system includes registration enablement information.

5. The method of claim 1 wherein:
the items ordered by the customer include components.

6. The method of claim 5 wherein:
when the determining determines components have been ordered by the customer, the information presented on the information handling system includes information relating to usage support of the components; and,
when the determining determines that components have not been ordered by the customer, the information presented on the information handling system includes component ordering enablement information.

7. An apparatus for customizing support of an information handling system comprising:
means for determining items ordered by a customer at a point of sale of the information handling system;
means for customizing support information presented on the information handling system based upon the items ordered by the customer.

8. The apparatus of claim 7 wherein:
the means for determining includes means for querying installation information to determine items ordered by the customer.

9. The apparatus of claim 7 wherein:
the items ordered by the customer include subscription services.

10. The apparatus of claim 9 wherein:
when the means for determining determines subscription services have been ordered by the customer, the information presented on the information handling system includes information relating to usage support of the subscription services; and,
when the means for determining determines that subscription services have not been ordered by the customer, the information presented on the information handling system includes registration enablement information.

11. The apparatus of claim 7 wherein:
the items ordered by the customer include components.

12. The apparatus of claim 11 wherein:
when the means for determining determines components have been ordered by the customer, the information presented on the information handling system includes information relating to usage support of the components; and,
when the means for determining determines that components have not been ordered by the customer, the information presented on the information handling system includes component ordering enablement information.

13. A system for customizing support of an information handling system comprising:
an order determination module, the order determination module determining items ordered by a customer at a point of sale of the information handling system;
a support customization module, the support customization module customizing support information presented on the information handling system based upon the items ordered by the customer.

14. The system of claim 13 wherein:
the order determination module queries installation information to determine items ordered by the customer.

15. The system of claim 13 wherein:
the items ordered by the customer include subscription services.

16. The system of claim 15 wherein:
when the order determination module determines subscription services have been ordered by the customer, the information presented on the information handling system includes information relating to usage support of the subscription services; and,
when the order determination module determines that subscription services have not been ordered by the customer, the information presented on the information handling system includes registration enablement information.

17. The system of claim 13 wherein:
the items ordered by the customer include components.

18. The system of claim 17 wherein:
when the order determination module determines components have been ordered by the customer, the information presented on the information handling system includes information relating to usage support of the components; and,
when the order determination module determines that components have not been ordered by the customer, the information presented on the information handling system includes component ordering enablement information.
